(19) United States
(12) Patent Application Publication
(10) Pub. No.: US 2003/0008589 A1
(43) Pub. Date: Jan. 9, 2003

(54) Moulding filter sheets

(75) Inventor: John Pritchard, Muir of Ord (GB)

Correspondence Address: MICHAEL BEST & FRIEDRICH, LLP, 100 E WISCONSIN AVENUE, MILWAUKEE, WI, 53202, US

(73) Assignee: P G Lawton (Industrial Services) Limited, Halifax (GB)

(21) Appl. No.: 10/150,725

(22) Filed: May 17, 2002

(30) Foreign Application Priority Data
May 18, 2001 (GB) 0112112.8

(51) Int. Cl. B32B 3/00; D04B 1/00; D04C 1/00; D04G 1/00; D03D 9/00; D03D 19/00; B32B 1/00; D04H 3/10; D04H 5/02

(52) U.S. Cl. 442/402; 428/174; 442/1; 442/20

(57) ABSTRACT

A layer 30 is shaped into the position shown in FIG. 1 and is attached to a plastic or steel plate 22 to fit the plate snugly. Pressure is applied to move the plate 20 and the plate 28 relative to each other towards each other to cause the water to be squeezed from a wet concrete mix 10 and to cause water to flow along the fabric sheet 26 and out through the fabric sheets 18 and 26.

The present invention relates to moulding fabric filter sheets, a method of making moulding fabric filter sheets, moulding apparatus and methods of moulding. The present invention is particularly, although not exclusively, applicable to moulding concrete blocks.

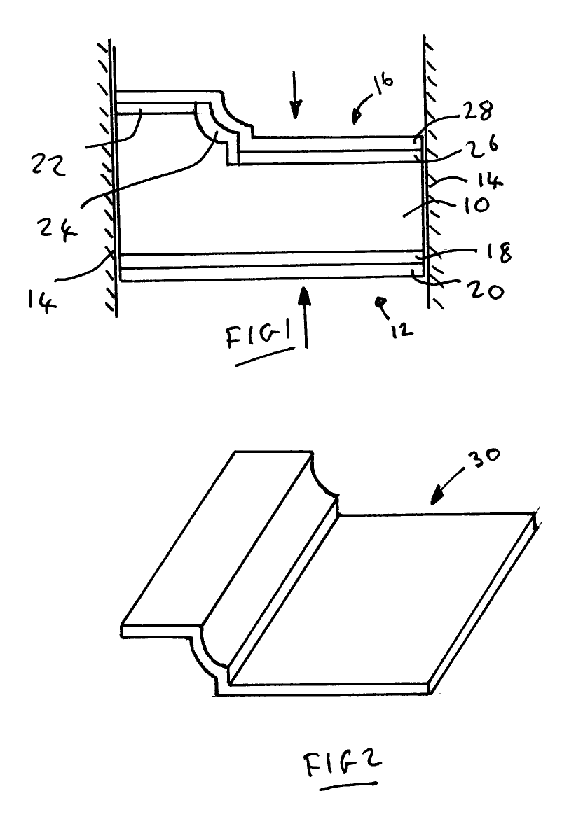

FIG. 1 is a schematic sectional view showing the moulding of curb stone 10. The wet mix 10 is first poured into a mould on top of a base 12 and within side walls 14. The side walls 14 may define a square or rectangular shape, in plan. It will be appreciated that the top surface of the concrete will, immediately after pouring, be substantially flat. However, when the top 16 of the mould is brought downwardly to compress the concrete, the concrete takes up the required shape of the curb stone 10, as shown.

After the shape has been formed, the top 16 is raised, the base 12 is raised through the side walls 14, and the curb stone 10 is then removed. Then the base is lowered to the position shown, more concrete is added and the process is repeated.

The base comprises a knitted fabric layer 18 that is fastened by rivets (not shown) to a plastic plate 20 having many perforations through it (not shown). Water from the mix, mostly during compression, is squeezed through the fabric and through the perforations in the plastic sheet to a drain (not shown). Similarly, the top 16 comprises three sections of fabric 22, 24 and 26 that are each fastened to a perforated plastic plate 28 by rivets (not shown). The fabric acts as a filter to allow water and air to pass through but to minimise the passage of any particles such as aggregate.

When the top is brought down to compress the concrete, the lower fabric section 26 first engages the flat concrete surface before the section 24 and finally the section 22. The concrete is squeezed and caused to take up the shape shown. During compression, water flows upwardly through the fabric layers 22, 24 and 26 and through the plate 28 to a drain (not shown). The removal of water at the top and bottom of the concrete is assisted by a suction force applied through the plates 20 and 28 and through the fabric layers mounted thereon. Each of the plates 20 and 28 is attached to a rigid supporting plate having openings for the water to be removed through. The compression forces are transferred through these rigid supporting plates. The force that is applied is of the order of 1 ton per square inch. Approximately 50% of the water may be removed.

Attaching the fabric layer 18 to the plate 20 is straight forward. The fabric is laid on, and riveted to the plastic. Forming the assembly of the plate 28 and its fabric layers is more difficult. First the shapes 22, 24, and 26 are cut from a layer of fabric. Then these have to be separately riveted to the plastic with the layer 24 having to be deformed or bent round into the curved shape shown. This is time consuming and requires accurate cutting of the fabrics.

The fabrics 22, 24 and 26 are cut as separate sections as the top surface would not be able to achieve the required shape if the fabric were cut as one piece. That is because whilst the fabric can conform largely to the contours of the plastic plate 28, the fabric cannot be completely flush with the plate over its complete surface. Although the fabric could be made as flexible as possible to try and minimise the area where the fabric is not in complete contact with the plate, the fabric must be thick enough to act as a filter. Thus it is difficult to effectively wrap the fabric around sharp bends such as the right angle shown and around sharp curves. Consequently when concrete is shaped with a top mould having a single fabric layer, the corners are not sharp and the edges of the top upper surface have a poor quality. That is because the fabric is pulled to try and conform more to the shape of the plastics sheet under the considerable compression force. That pulling reduces the cross-sectional area of the fabric, when viewed in plan. Consequently at the exposed upper peripheral regions no filter is present and the concrete has a rough finish with the surface being washed away. In most cases that is unacceptable.

A further problem with a rough finish is that, in use, dust can come off the concrete. Where the concrete is being used as a weight in a washing machine, the dust can damage the machine such as by interfering with the electrical system. With weights for the washing machine purpose it is desired to make the weight as small as possible for a given weight. Thus slag grit is used. This is expensive though. Consequently blocks that have too many defects to enable them to be serviceable are wasted, at great cost.

The provision of the three separate fabric pieces reduces this problem. However, it does not eliminate it completely. For instance, the layer 24 goes around the curve and then downwardly around a corner. Consequently the top and bottom edges seen in FIG. 1 of the layer 24 will be pulled away from the adjacent layers, during compression, to leave lengths of surface area that have the rough finish referred to earlier. This can be attempted to be avoided by overlapping the adjacent layers. However, the overlapped edges leave an unwanted step in the finished product. Either way a downstream operation is required to try and remove the unsightly steps and rough portions. This is time consuming and costly.

A further problem with the provision of the three different fabric layers is that water is not able to be removed equally from all areas of the top surface. In this respect, the knitted fabric allows flow of water along the layer. That is fine where the sheet is in one piece as satisfactory removal of water is possible. With the upper region of the layer 24, for instance, the water will be pulled and flow towards the upper edge. However, because the layer extends upwardly at this region there is very little surface area through which water can be pulled away from. Consequently there is a considerable discrepancy over the surface of the curb stone with regard to the water that is removed which results in the stone having a non uniform surface or appearance.

It is an object of the present invention to attempt to overcome at least one of the above or other disadvantages. According to one aspect of the present invention a moulding fabric filter sheet includes a self retaining shape that is other than planar.

The self retaining shape may include at least one curved section, one or more curved sections having different curvatures, at least one flat section or preferably two flat sections extending in different planes, at least one angled section which may undergo a change in direction of, for instance, more than 20° or less than 90° or approximately 90° or any combination thereof.

The fabric may be a knitted fabric, woven fabric or a needled fabric, in which case the fabric may be needled to a scrim. The fabric may include polypropylene fibres.

The filter sheet may be arranged to be attached to a supporting member including the same shape as the retained shape of the sheet.

The self retaining shape may have been achieved by heating the sheet and, for instance, subsequently cooling the sheet.

According to a further aspect of the present invention a method of making a moulding fabric filter sheet comprises placing a sheet in a mould having the shape that the sheet is required to retain, heating the sheet and cooling the sheet.

The method may comprise cooling the sheet in or out of the mould.

The method may comprise making the sheet, prior to shaping the sheet by needling fibres, for instance to scrim, or by knitting fibres or by weaving or any combination thereof. The method may comprise varying the porosity of the sheet in accordance with the intended use of the sheet by, for instance, varying the needling effect or the weaving effect or the knitting action or by varying the construction.

According to another aspect of the present invention moulding apparatus comprises a moulding region in which, in use, a product to be moulded is arranged to be located, and two spaced portions movable relative to each other, towards each other in order that at least one of those portions can impart a shape to the product being moulded, at least one of those portions including a fabric filter sheet which has had a self retaining shape applied to it.

The sheet which has had a self retaining shape applied to it may comprise a moulding fabric filter sheet as herein referred to or a moulding fabric filter sheet that has been made by a method as herein referred to.

According to another aspect of the present invention a method of moulding comprises locating a product to be moulded in a moulding region, moving two spaced portions relative to each other towards each other with at least one of those spaced portions including a fabric filter sheet that has had a self retaining shape applied to it whereby the product takes up the exact shape of the self retaining shape of the filter sheet with liquid being removed through the sheet during moulding.

The present invention includes concrete moulding apparatus and a method of moulding concrete by the apparatus and method herein referred to.

According to a further aspect of the present invention a moulding fabric filter sheet includes needled fibres.

The needled fibres may be connected to a supporting layer by needling, such as a supporting layer comprising a scrim.

The fabric may have a self retaining shape.

According to a further aspect of the present invention a method of forming a moulding fabric filter sheet comprises needling fibres to comprise at least part of the sheet.

The present invention includes any combination of the herein referred to features or limitations. The present invention can be carried into practice in various ways and several embodiments will now be described, by way of example, and with reference to the accompanying FIG. 2 which is a schematic section view of a fabric layer 30.

The layer 30 is shaped into the position shown. Consequently when it is attached to a plastic or steel plate 28, such as by rivets or adhesive dots or a spray adhesive, shown in FIG. 1 the layer 30 will fit the plate snugly. If necessary the layer can be trimmed to fit the mould prior to, or when attached to the plate 28. Thus when a curb stone is being formed under compression, the layer 30 will not be pushed in to expose the sides. Furthermore, there will be no joint apparent between any sections as the layer is made in one piece. In addition, if the fabric is knitted then water will flow along the fabric, for instance around the curved portion, and around the corner into the adjacent upper flat portion to help ensure that there is a more even removal of water over the surface to further improve the appearance of the curb stone.

The shaped fabric can be formed in any suitable way. For instance the fabric can be knitted, woven or needled from polypropylene fibre, for example. The fabric can then be placed in a mould for shaping the fabric with heat and light pressure being applied to soften the fibres and to allow the fabric to take up the required shape. The fabric can then be cooled, either inside or out of the mould. The fabric maintains its shape after such treatment. It will be appreciated that more complicated shapes could be provided with the pre shaped fabric layer. For instance, the curvature may vary or may leave the upper surface having a domed or hollowed appearance. Furthermore, the lower face of the mould may also be provided with a pre shaped fabric filter as herein referred to.

With the needled fabric, fibres are aligned transverse to the general plane of the layer. Consequently water is able to flow across these layers fairly easily. Thus, with needled fabric, some advantages over the prior art will be achieved if this fabric is used in a shaped mould with the fabric not being pre shaped and possibly also by being cut to provide separate pieces, as described in relation to FIG. 1.

When needling the fabric, the fibres can be needled to a scrim such as a NYLON scrim. With this arrangement it may not be necessary to provide a separate plastic plate and the combined scrim and fabric could be attached directly to the rigid shaped supporting plate.

In a further modification to the present invention, the needling, weaving or knitting operations can be varied to increase or decrease the porosity of the fabric.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A moulding fabric filter sheet including a self retaining shape that is other than planar.

2. A sheet as claimed in claim 1 including at least one curved section.

3. A sheet as claimed in claim 1 including at least one curved section having different curvatures.

4. A sheet as claimed in claim 1 including more than one curved section having different curvatures.

5. A sheet as claimed in claim 1 including two flat sections extending in different planes.

6. A sheet as claimed in claim 1 including at least one angled section.

7. A sheet as claimed in claim 7 in which the angled section undergoes a change in direction of approximately 90°.

8. A sheet as claimed in claim 1 including a scrim and in which the fabric is needled to the scrim.

9. A sheet as claimed in claim 8 in which the needled fabric is needled to a scrim.

10. A sheet as claimed in claim 1 including polypropylene fibres.

11. A sheet as claimed in claim 1 arranged to be attached to a supporting member including the same shape as the retained shape of the sheet.

12. A sheet as claimed in claim 1 in which the self retaining shape has been achieved by heating the sheet.

13. A method of making a shaped moulding fabric filter sheet comprising placing a sheet in a mould having the shape that the sheet is required to retain, heating the sheet and cooling the sheet such that the sheet retains the shape.

14. A method as claimed in claim 13 comprising cooling the sheet in the mould.

15. A sheet as claimed in claim 13 comprising cooling the sheet out of the mould.

16. A method as claimed in claim 13 comprising making the sheet prior to shaping the sheet by needling fibres.

17. A method as claimed in claim 13 comprising varying the porosity of the sheet in accordance with the intended use of the sheet.

18. A sheet as claimed in claim 17 comprising varying the porosity by varying a needling effect.

19. A sheet as claimed in claim 17 comprising varying the porosity by varying a weaving effect.

20. A sheet as claimed in claim 17 comprising varying the porosity by varying the construction.

21. Moulding apparatus comprising a moulding region in which, in use, a product to be moulded is arranged to be located and two spaced portions movable relative to each other towards each other in order that at least one of those portions can impart a shape to the product being moulded, at least one of those portions including a fabric filter sheet which has had a self retaining shape applied to it.

22. A sheet as claimed in claim 21 in which the fabric filter sheet which has had a self retaining shape applied to it comprises a moulding fabric filter sheet as claimed in any of claims 1.

23. A method of moulding comprising locating a product to be moulded in a moulding region, moving two spaced portions relative to each other towards each other with at least one of those spaced portions including a fabric filter sheet that has had a self retaining shape applied to it whereby the product takes up the exact shape of the self retaining shape of the filter sheet with liquid being removed through the sheet during moulding.
